(19) United States
(12) Patent Application Publication
(10) Pub. No.: US 2023/0136250 A1
(43) Pub. Date: May 4, 2023

(54) SYSTEMS AND METHODS FOR PRODUCT VALIDATION

(71) Applicant: CyberSoteria Limited Company, Coppell, TX (US)

(72) Inventors: Lixiang Chen, Coppell, TX (US); Courtney Jane Chen, Dallas, TX (US)

(21) Appl. No.: 17/452,674

(22) Filed: Oct. 28, 2021

(51) Int. Cl. G06Q 30/00; G06F 7/58

(52) U.S. Cl. CPC G06Q 30/0185; G06F 7/58

(57) ABSTRACT

Methods for product authenticity verification and corresponding systems and computer-readable mediums. A method includes receiving and storing product data corresponding to a product. The method includes generating and storing a validation seed associated with the product data. The method includes generating and storing a validation identifier (ID) using at least the validation seed. The method includes returning the generated validation ID. The validation ID can thereafter be used to create a validation marker that is applied to the product.

### CROSS-REFERENCE

The present application contains some subject matter in common with, but is otherwise unrelated to, concurrently-filed U.S. Pat. No. ______, titled “Systems and Methods for Product Ownership Recordation and Validation” (docket number CYBE01-00003).

### TECHNICAL FIELD

The present disclosure is directed, in general, to systems and methods for validating genuine products. Various embodiments include systems and methods for generating identifiers for uniquely and securely marking products and systems and methods for validating the identifiers.

### BACKGROUND OF THE DISCLOSURE

Each year, the loss attributed to counterfeit products continues to increase. In 2017, the estimated global estimated loss caused by product counterfeiting was $1.2 trillion USD, and that estimation reached $1.82 trillion USD in 2020. Product counterfeiting is damaging to the legitimate manufacturers, the affected industry, and national and global economies.

One practice that is employed by manufacturers and retailers to track their goods and to prevent counterfeiting is to use one-or two-dimensional printed barcodes or Near-Field Communication (NFC) chips. However, the barcode or the contents of an NFC chip can be copied, replicated, or decoded by counterfeiters and therefore cannot function to confirm the authenticity or provenance of the product. As a result, counterfeits with the same product code are sold or exchanged without being detected. Improved systems are desirable.

### SUMMARY OF THE DISCLOSURE

Various disclosed embodiments include methods for product authenticity verification and corresponding systems and computer-readable mediums. A method includes receiving and storing product data corresponding to a product. The method includes generating and storing a validation seed associated with the product data. The method includes generating and storing a validation identifier (ID) using at least the validation seed, and, in some case, also using the product data. The method includes returning the generated validation ID. The validation ID can thereafter be used to create a validation marker that is applied to the product.

The method can also include receiving a second validation ID. The method can also include determining whether the second validation ID is valid by determining whether the second validation ID matches the previously stored validation ID. The method can also include returning a validation result based on the determination. The validation ID can be extracted from a validation marker applied to a product to be verified.

In various embodiments, the product data include one or more of a brand name of the product, a manufacturer ID for a manufacturer of the product, a model name of the product, a model number of the product, a universal product code of the product, a serial number of the product, an expiration date of the product, a manufacture date of the product, a sales date of the product, a store ID of a store that sells the product, a store ID of a store to which the product is being shipped, or a retailer ID.

In various embodiments, the product data includes an address to verify the product. In various embodiments, the validation seed is a randomly or pseudo-randomly generated number. In various embodiments, generating the validation seed includes combining the validation seed and the associated product data and using a hash function on the combined validation seed and associated product data to produce an encoded result that is used as the validation ID. In various embodiments, generating the validation seed includes combining the validation seed and the associated product data and using a cryptographic function on the combined validation seed and associated product data to produce an encoded result that is used as the validation ID. In various embodiments, when the second validation ID is not determined to be valid, then the validation result is a message or code sent to indicate that the second validation ID is not valid. In various embodiments, when the second validation ID is determined to be valid, then the validation result is a message or code sent to indicate that the second validation ID was valid determined to be valid. In various embodiments, when the second validation ID is determined to be valid, then the validation result includes some or all of the product data associated with the previously-stored validation ID.

Various embodiments include a data processing system having a memory and at least one processor operatively connected to the memory and configured to perform processes as described herein. Various embodiments include a machine-readable medium encoded with executable code that, when executed, cause one or more processors to perform processes as described herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a system 100 in which various embodiments can be implemented;

FIG. 2 illustrates a block diagram of a data processing system in which an embodiment can be implemented;

FIG. 3 illustrates a flowchart of a process in accordance with disclosed embodiments; and

FIG. 4 illustrates a flowchart of a process in accordance with disclosed embodiments.

### DETAILED DESCRIPTION

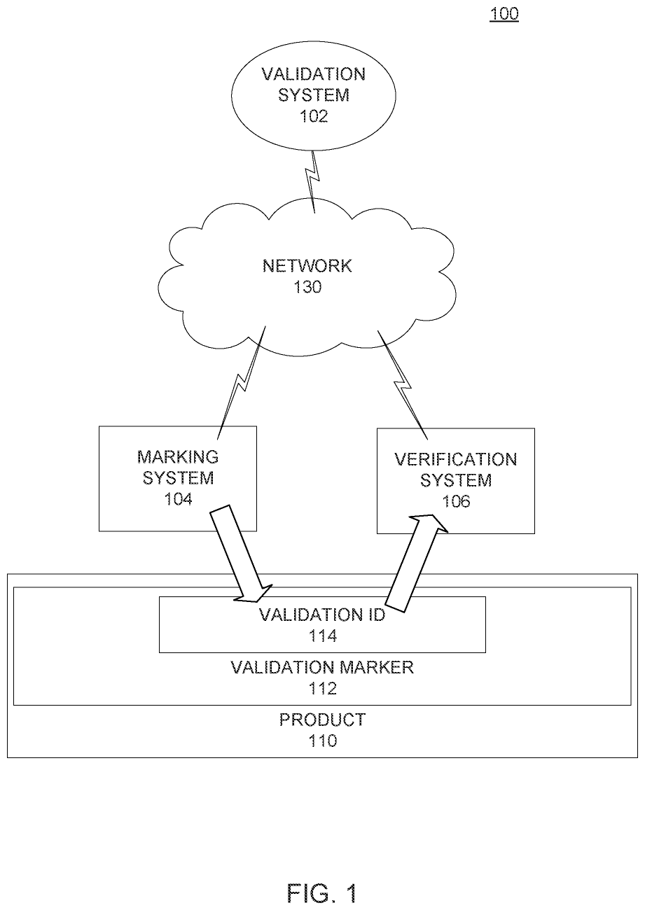

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include for generating “validation identifiers” (or “validation IDs”) for uniquely and securely marking products and thereafter validating the validation identifiers to ensure that the product is genuine. The “products” can be physical products that are marked with a barcode or NFC, radio-frequency identification (RFID), or other electronic device that includes the validation identifiers described herein, the packaging of physical products where the packaging is marked with such a barcode or NFC/RFID electronic device, or other products such as software or other digital media that includes such a validation identifier in or associated with the digital media.

A “barcode” as used herein generally refers to a “matrix” barcode, such as a two-dimensional (2D) barcode or a “QR code,” but is also intended to include any machine-readable indicia capable of including or being encoded with a validation identifier as described herein, including but not limited to one-dimensional (1D) barcodes. Similarly, while an NFC or RFID electronic device is used to illustrate specific embodiments, the disclosure herein is intended to include any machine-accessible electronic device that includes the validation identifiers described herein and can be read by a computer, scanner, or other device to receive the validation identifiers either by wired connection, wirelessly, or otherwise. A “validation marker,” as used herein and unless otherwise limited, refers to any machine-readable, human-readable, or other physical or electronic marking that is applied to or associated with a product or its packaging and from which the validation identifier can be read or associated, whether a barcode, an NFC, RFID, or other electronic device, a validation identifier embedded in software or other digital media, a physical or electronic authenticity certificate, or otherwise.

In various embodiments, a “cloud” service or server data processing system, generally referred to as the “validation system” herein, can be used to generate the validation identifiers for a product, and that validation identifier can be represented in a validation marker for the product. When a purchaser or other individual desires to validate the product, the validation marker can be read to extract the validation identifier, which is sent to the validation system. The validation system confirms or denies the validation using processes described herein and can return the validation to the individual.

FIG. 1 illustrates an example of a system 100 in which various embodiments can be implemented, from a high-level perspective. In this example, validation system 102 represents one or more data processing systems (also referred to simply as computers) configured to perform processes as described herein, which can include generating the validation IDs, processing received validation IDs to confirm or deny validation of a product, sending validation codes or responses, and others. Note that while validation system 102 is illustrated as a single “system,” validation system 102 can be implemented as one or more computers whether commonly located, distributed, implemented in physical or virtual machines, as a private server system or systems, as a cloud system or otherwise, and the operations of the validation system 102 may be under the control of the owner(s) of the physical computer(s) or of a party or parties that contract for processing on the physical computers. Moreover, specific operations described herein may be performed by different physical or virtual computers, whether concurrently or at different times, and so the validation system 102 as may be claimed herein should be understood to include only those computers performing processes required by a specific claim or claims at issue.

In this example, validation system 102 communicates over network 130 with one or more other computers as described herein. Network 130 represents any combination of public or private computer networks, including the Internet, whether wired or wireless, and will be generally understood to include any data communication path(s) between the validation system and the respective other computers.

In this example, marking system 104 represents one or more data processing systems configured to send product information for a product to the validation system 102 and to thereafter receive a validation ID 114 for the product 110 to be used for a validation marker 112 for the product 110. Marking system 104 may also be configured to actually produce the validation marker 112 corresponding to the validation ID 114, such as printing a barcode or other indicia, encoding an NFC, RFID, or other electronic device with the validation ID 114, inserting or embedding the validation ID 114 into software or other digital media, generating a physical or electronic authenticity certificate, or otherwise. Disclosed embodiments can include any means of applying or associating the validation marker 112 with the product 110, whether performed by marking system 104 itself or not.

In this example, verification system 106 represents one or more data processing systems configured to send a validation ID 114 for a product 110 to the validation system 102 and to thereafter receive a confirmation or denial from the validation system 102 as to whether the validation ID 114 represents a genuine product. Verification system 106 may also be configured to read the validation marker 112 to obtain the validation ID 114, such as by scanning a optically barcode or other indicia, wirelessly reading an NFC, RFID, or other electronic device to extract the validation ID 114, analyzing, scanning, or reading software or other digital media to determine the validation ID 114, receiving an input from a user that includes the validation ID 114 such as from a physical or electronic authenticity certificate, or otherwise. Disclosed embodiments can include any device or process used for identifying the validation ID 114 corresponding to the product 110 from a validation marker 112, whether performed by verification system 106 itself or not.

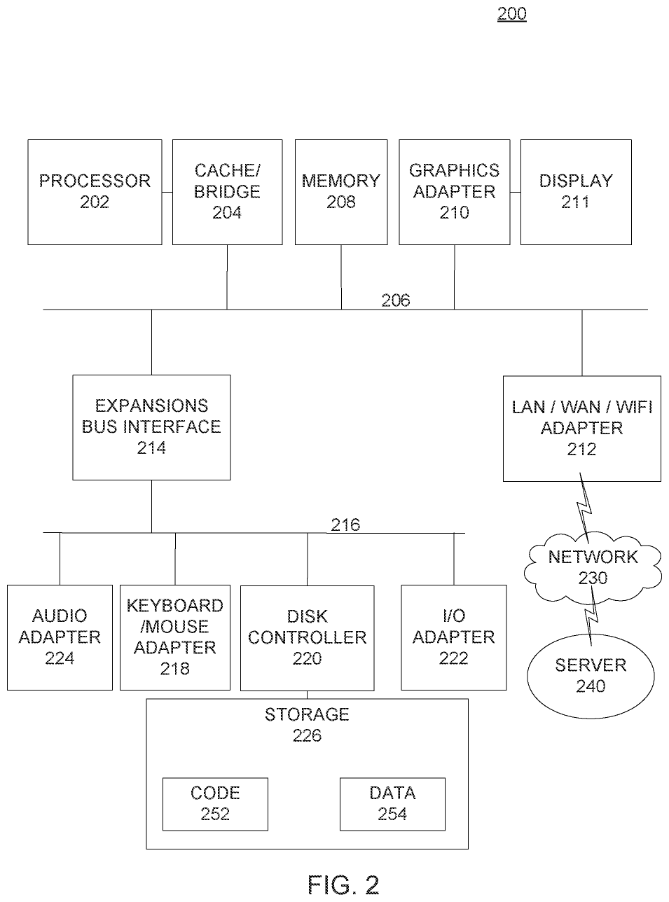

FIG. 2 illustrates a block diagram of a data processing system in which an embodiment can be implemented, for example as a computer system particularly configured by software or otherwise to perform the processes as described herein, and in particular as each one of a plurality of interconnected and communicating systems as described herein. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210. The graphics adapter 210 may be connected to display 211.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 216 is connected to keyboard/mouse adapter 218, disk controller 220, and I/O adapter 222. Disk controller 220 can be connected to a storage 226, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 226 can store any data or code necessary for or usable in disclosed embodiments, and in particular can store executable code 252, which when executed cause one or more processors to perform processes as described herein, and data 254, which can include any of the data processed, generated, or stored as described herein.

Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, touchscreen, etc. I/O bus 216 can also be connected to other peripheral devices in various embodiments, such as (but not limited to) a printer, a optical scanner, an NFC, RFID, or other reader, a camera, or others.

Those of ordinary skill in the art will appreciate that the hardware depicted in FIG. 2 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure. In some embodiments, data processing system 100 can be implemented as one of multiple computers together implementing a system as described herein. In some embodiments, a data processing system 100 can be implemented, in whole or in part, with or as a part of a server computer, a desktop computer, a laptop computer, a portable electronic device or mobile device such as a tablet or mobile phone, or otherwise.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 212 can be connected to a network 230 (not a part of data processing system 200), which can be any public or private data processing system network or combination of networks, as known to those of skill in the art, including the Internet, and which can correspond to network 240. Data processing system 200 can communicate over network 230 with server system 240, which is also not part of data processing system 200, but can be implemented, for example, as a separate data processing system 200.

Some systems embed limited product information into 1D or 2D barcodes or QR codes. This product information may include a company website address, manufacturer name, product model, or a product expiration date. The product information is converted from its “raw” form into a 2D barcode, and the 2D barcode with the limited product information is applied to the product. In general, the same 2D barcode is used for a large number of products since the limited product information is common to many products. For example, if the product information includes only a manufacturer name and company website address, then the same 2D barcode can be and often is used for all products by that company and manufacturer. Even if more-limited information such as a specific product model or expiration date is included, the same 2D barcode is typically used for all products that share those attributes.

These systems fail in that the barcode can easily be duplicated and applied to counterfeit products since there is no technological barrier to doing so.

Disclosed embodiments provide a technological improvement to product validation by adding using a security key to generate a product-specific validation ID that can be used as a validation marker as described herein. The disclosed validation marker protects the product from being counterfeited since the counterfeiter cannot replicate the validation marker.

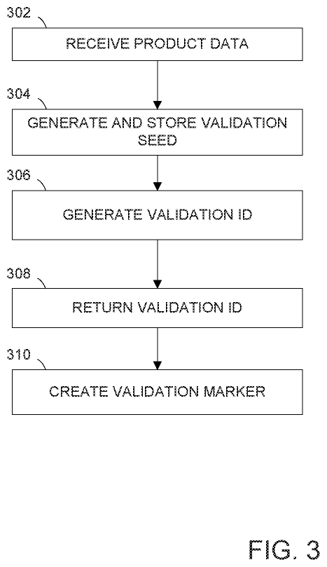

FIG. 3 illustrates a process in accordance with disclosed embodiments that be performed, for example, by verification system 106 as described herein or other system configured to perform processes as described, singularly or in combination with other systems, referred to generically as the “system” in this process. The process of FIG. 3 can be used to create validation IDs and validation markers for a product or set of products.

The system receives and stores product data corresponding to a product or set of products (302). Product data can include, for example, the brand name of the product, a manufacturer ID for the manufacturer of the product, the model name or number of the product, the universal product code (UPC) of the product, the serial number of the product, an expiration date of the product, a manufacture date of the product, a sales date of the product, a store ID or other information of the store that is selling the product or to which the product is being shipped, a retailer ID or other information of the retailer (e.g., a retail store chain) that is selling the product or to which the product is being shipped, or other information about a product. In some cases, the product data can include a URL or other address to verify the product at the validation system. Any one of these elements or any combination of these elements can be used as the product data in various embodiments. In some cases, the system can also receive a user ID along with the product data, and stores the user ID as associated with the product data.

In some cases, it is preferred that the elements comprising the product data is standardized for particular products or applications. For example, for a television, the product data may comprise the manufacturer ID of the product, the model number of the product, and a retailer ID of the product, which would be sufficient to identify a set of products of a certain model that are legitimately sold by that retailer. It is also preferable, in some cases, that the elements comprising the product data are discernable by a buyer, seller, or other individual after the product has been placed in commerce, so that the individual can assemble the same product data for his product to determine if the product is genuine.

The system can receive the product data from a marking system 104, which may be operated by, for example, the manufacturer or distributor of the product, the retailer of the product or otherwise, to generate a validation ID and validation marker for those products. In the example above, product data may be received from a marking system operated by the product manufacturer to identify a set of products being sent to a specific retailer. The system can receive the product data over the Internet or other network 130. In other cases, the validation system and the marking system may be the same computer or set of computers so that “receiving” and “returning” refer to exchanging data between computer processes.

The system generates and stores a validation seed associated with the product data (304). The validation seed is any number, string, or other data used to uniquely produce the validation ID from the product data. The validation seed can be, for example, a randomly or pseudo-randomly generated number.

The system generates and stores a validation ID using the validation seed and, in some cases, the associated product data (306). The validation ID can be stored as associated with the product data and the validation seed. That is, the validation ID can be generated, in various embodiments, using the validation seed alone, the combined validation seed and product data, or the validation seed in combination with other objective data so that the generation is reproducible.

For example, to generate the validation ID, the system can concatenate or otherwise combine the validation seed and the associated product data and use a hash function or cryptographic function on the combined validation seed and associated product data to produce an encoded result that is used as the validation ID. The hash function, in this example, can be cyclic redundancy check algorithm, ad checksum algorithm, a universal hash function algorithm, a non-cryptographic hash function algorithm, a keyed cryptographic hash function algorithm, an unkeyed cryptographic hash function algorithm, or otherwise. The cryptographic function can be any cryptographic function that can use the combined validation seed and associated product data to produce the encoded result that is used as the validation ID.

In some cases, where the encoded result is a value or string that is longer than necessary or useful as a validation ID, a portion of the encoded result can be used as the validation ID. For example, if the encoded result is 256 characters, it may be sufficient to use only the first 64 or last 64 digits as the validation ID.

In some cases, the validation seed can be “combined” with the associated product data by using the validation seed as the encryption seed or encryption code for the cryptographic function performed on the associated product data.

In any case, disclosed embodiments provide that producing the validation ID is repeatable for a given validation seed and associated product data, so that the same validation ID is produced each time a given validation seed and associated product data is used in 306.

The validation ID is therefore an encoded identifier that is specific to that validation seed and the associated product data. Preferably, the validation seed is stored as associated with the product data and not revealed to any third parties, so that the validation ID can only be reproduced using that validation seed, its associated product data, and the corresponding hash function or encryption function. Conversely, the validation ID cannot be generated by third parties that do not know that validation seed, its associated product data, and the corresponding hash function or encryption function.

The system can return the validation ID to the marking system (or to another system) (308). The system can return the validation ID over the Internet or other network 130. In some cases, the validation ID can then be discarded by the system rather than stored persistently, since it can be regenerated on need using the same validation seed.

The marking system creates a validation marker corresponding to the validation ID (310). The validation marker can be in any of the forms as described herein, and typically is in a machine-readable form whether in a barcode, an NFC, RFID, or other device, embedded in software or digital media or otherwise. The validation marker may be “created” by, for example, printing a barcode, encoding the validation ID in an NFC, RFID, or other device, embedding the validation ID in software or other digital media, or otherwise. The validation marker can include other information as well as corresponding to the validation ID, such as UPC information, manufacturer information, validation information, or other information.

The validation marker is applied to the set of products corresponding to the product data, where it can thereafter be used to validate the set of products as authentic using processes described herein. Applying the validation marker may be part of creating it (such as when embedding in digital media) or may be separate process performed to physically apply or print the barcode, other indicia, NFC device, RFID device, or other form of validation marker to a product and/or its packaging. In some cases, the validation marker can include or be applied together with a URL or other address to verify the product at the validation system.

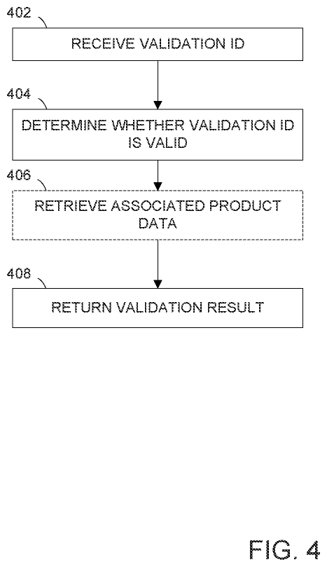

FIG. 4 illustrates a process in accordance with disclosed embodiments that be performed, for example, by verification system 106 as described herein or other system configured to perform processes as described, singularly or in combination with other systems, referred to generically as the “system” in this process. The process of FIG. 4 can be used to verify a product data for a product or set of products based on a validation marker to determine if the products are genuine.

The system receives a (second, in some cases) validation ID (402). The system can receive the validation ID from a verification system 106, which may be operated by, for example, a retailer, seller, or potential buyer of the product or otherwise. For example, the validation system 106 could be a computer system or mobile device that scans the validation marker on a product to extract the validation ID from the validation marker. In some cases, the validation system can optically scan a barcode or other indicia, on the product or its packaging, that is acting as the validation marker to extract the validation ID encoded in the indicia. In other cases, the validation system can use an NFC or RFID receiver to extract the validation ID from an NFC or RFID device, on the product or its packaging, that is acting that is acting as the validation marker to extract the validation ID encoded in the NFC or RFID device. In other cases, the validation system can scan software or other digital media to extract the validation ID encoded in or stored in the software or digital media.

In cases where the validation marker included or was applied together with a URL or other address to verify the product at the validation system, the process can be automated at the verification system so that the verification system scans the validation marker and uses the URL, a designated web address, or other address to automatically extract the validation ID and send to the validation system.

The system determines whether the received validation ID is valid by determining whether it matches a previously-generated and stored validation ID (404). As above, in some cases, the “previously-generated and stored validation ID” may be a validation ID that is regenerated from the validation seed (as described above) and temporarily stored in order to make the determination.

The system can use (or attempt to use) the received validation ID to retrieve the stored associated product data (406).

The system returns a validation result to the verification system based on the determination (408). In the case that the received validation ID is invalid, the validation result will be error message, “counterfeit product” message, “code not valid” message, or similar message or code sent to the verification system to indicate that the validation ID was not valid. This message can include the product data and product history information.

In the case that the received validation ID is valid in that it matches a previously-stored validation ID, the validation result can be a simple “code valid” message or similar message or code sent to the verification system to indicate that the validation ID was valid. In other cases, when the received validation ID is valid in that it matches a previously-stored validation ID, the validation result can include some or all of the product data associated with the previously-stored validation ID, sent to the verification system to indicate so that the user can confirm that the product data matches the product being verified. This message can include the product data and product history information. In various embodiments, the validation result the validation result can include some or all of the product data, and the product history data associated with the previously-stored validation ID, or another unique product identifier ID, such as the combination of product code and its serial number.

Disclosed embodiments provide technical advantages and improvements in product authentication, brand protection, and cost avoidance from counterfeiting goods. Disclosed embodiments ensure the uniqueness of the secured product barcode by including the unique validation ID. The validation ID can be unique to specific individual products or sets of products, and therefore can enable a manufacturer or other party to track each item made. Disclosed embodiments create verification markers that are unpredictable so that counterfeiting entities cannot produce a valid barcode or other verification marker.

Disclosed embodiments can be used to track and verify a product through the product's entire lifecycle.

Of course, those of skill in the art will recognize that, unless specifically indicated or required by the sequence of operations, certain steps in the processes described above may be combined, omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method for product authenticity verification, the method performed by a data processing system and comprising:
receiving and storing, by the data processing system, product data corresponding to a product;
generating and storing, by the data processing system, a validation seed associated with the product data;
generating and storing, by the data processing system, a validation identifier (ID) using at least the validation seed; and
returning, by the data processing system, the generated validation ID,
wherein the validation ID is thereafter used to create a validation marker that is applied to the product.

2. The method of claim 1, wherein the product data include one or more of a brand name of the product, a manufacturer ID for a manufacturer of the product, a model name of the product, a model number of the product, a universal product code of the product, a serial number of the product, an expiration date of the product, a manufacture date of the product, a sales date of the product, a store ID of a store that sells the product, a store ID of a store to which the product is being shipped, or a retailer ID.

3. The method of claim 1, wherein the product data includes a designated web address to verify the product.

4. The method of claim 1, wherein the validation seed is a randomly or pseudo-randomly generated number.

5. The method of claim 1, wherein generating the validation seed includes combining the validation seed and the associated product data and using a hash function on the combined validation seed and associated product data to produce an encoded result that is used as the validation ID.

6. The method of claim 1, wherein generating the validation seed includes combining the validation seed and the associated product data and using a cryptographic function on the combined validation seed and associated product data to produce an encoded result that is used as the validation ID.

7. The method of claim 1, further comprising:
receiving a second validation ID, by the data processing system;
determining, by the data processing system, whether the second validation ID is valid by determining whether the second validation ID matches the previously stored validation ID; and
returning a validation result, by the data processing system, based on the determination,
wherein the validation ID is extracted from a validation marker applied to a product to be verified.

8. The method of claim 7, wherein when the second validation ID is not determined to be valid, then the validation result is a message or code sent to indicate that the second validation ID is not valid.

9. The method of claim 7, wherein when the second validation ID is determined to be valid, then the validation result is a message or code sent to indicate that the second validation ID was valid determined to be valid.

10. The method of claim 7, wherein when the second validation ID is determined to be valid, then the validation result includes some or all of the product data associated with the previously-stored validation ID.

11. A data processing system, comprising:
a memory; and
at least one processor operatively connected to the memory, wherein the at least one processor is configured to:
receive and store product data corresponding to a product;
generate and store a validation seed associated with the product data;
generate and store a validation identifier (ID) using at least the validation seed; and
return the generated validation ID,
wherein the validation ID is thereafter used to create a validation marker that is applied to the product.

12. The data processing system of claim 11, wherein the product data include one or more of a brand name of the product, a manufacturer ID for a manufacturer of the product, a model name of the product, a model number of the product, a universal product code of the product, a serial number of the product, an expiration date of the product, a manufacture date of the product, a sales date of the product, a store ID of a store that sells the product, a store ID of a store to which the product is being shipped, or a retailer ID.

13. The data processing system of claim 11, wherein the validation seed is a randomly or pseudo-randomly generated number.

14. The data processing system of claim 11, wherein the at least one processor is further configured to:
receive a second validation ID;
determine whether the second validation ID is valid by determining whether the second validation ID matches the previously stored validation ID; and
return a validation result based on the determination,
wherein the validation ID is extracted from a validation marker applied to a product to be verified.

15. The data processing system of claim 11, wherein when the second validation ID is not determined to be valid, then the validation result is a message or code sent to indicate that the second validation ID is not valid.

16. The data processing system of claim 11, wherein when the second validation ID is determined to be valid, then the validation result is a message or code sent to indicate that the second validation ID was valid determined to be valid, or the validation result includes some or all of the product data associated with the previously-stored validation ID.

17. A machine-readable medium encoded with executable code that, when executed, cause one or more processors to:
receive and store product data corresponding to a product;
generate and store a validation seed associated with the product data;
generate and store a validation identifier (ID) using at least the validation seed; and
return the generated validation ID,
wherein the validation ID is thereafter used to create a validation marker that is applied to the product.

18. The machine-readable medium of claim 17, further encoded with executable code that, when executed, cause the one or more processors to:
receive a second validation ID;
determine whether the second validation ID is valid by determining whether the second validation ID matches the previously stored validation ID; and
return a validation result based on the determination,
wherein the validation ID is extracted from a validation marker applied to a product to be verified.

19. The machine-readable medium of claim 17, wherein when the second validation ID is not determined to be valid, then the validation result is a message or code sent to indicate that the second validation ID is not valid.

20. The machine-readable medium of claim 17, wherein when the second validation ID is determined to be valid, then the validation result is a message or code sent to indicate that the second validation ID was valid determined to be valid, or the validation result includes some or all of the product data associated with the previously-stored validation ID.
